(19) United States
(12) Patent Application Publication
(10) Pub. No.: US 2012/0160397 A1
(43) Pub. Date: Jun. 28, 2012

(54) MOUNTED WAFER MANUFACTURING METHOD

(76) Inventors: Masayuki Yamamoto, Osaka (JP); Saburo Miyamoto, Kameyama-shi (JP)

(21) Appl. No.: 13/312,997

(22) Filed: Dec. 7, 2011

(30) Foreign Application Priority Data
Dec. 24, 2010 (JP) 2010-288083

(51) Int. Cl. B32B 38/10

(52) U.S. Cl. 156/154

(57) ABSTRACT

A liquid adhesive is applied to a circuit surface of a semiconductor wafer. A carrier is joined to a surface of the semiconductor wafer coated with the adhesive. A rear face of the semiconductor wafer is ground while the carrier is held. The semiconductor wafer is supported on a ring frame via a support adhesive tape. The carrier is removed from the semiconductor wafer. The adhesive tape is separated integrally with the film-like adhesive from the semiconductor wafer through joining a separation tape having a width larger than a diameter of the semiconductor wafer to the adhesive on the semiconductor wafer and then separating the separation tape.

### BACKGROUND OF THE INVENTION

(1) Field of the Invention

This invention relates to a method for manufacturing a mounted wafer by joining a support adhesive tape to a semiconductor wafer reinforced through joining a carrier thereto via an adhesive, and subsequently by removing the carrier and the adhesive from the semiconductor wafer.

(2) Description of the Related Art

In recent years, a semiconductor wafer (hereinafter, appropriately referred to as a “wafer”) tends to be ground to have a thickness of several tens micrometers with a need for a high-density package. The thinned wafer has lower rigidity. Accordingly, prior to a back grinding process, a carrier is joined to the wafer via a double-faced adhesive tape with an adhesive layer of a heating separation property. Herein, the carrier has a shape similar to the wafer and a size not less than the wafer.

The wafer with the carrier that is subject to a back grinding process is joined to a ring frame via a support double-faced adhesive tape. Subsequently, a rear face of the wafer is suction-held with a lower suction table, and a surface of the wafer on the carrier is suction-held with an upper suction table having a heater embedded therein. The upper suction table then moves upward while heating the carrier. Here, an adhesion layer of the double-faced adhesive tape with a heating separation property foams and expands, thereby losing its adhesion. As a result, the carrier and the double-faced adhesive tape are integrally separated from the surface of the wafer. Alternatively, the carrier is removed from the wafer with the double-faced adhesive tape remaining on the wafer. See Japanese Patent Publication No. 2005-116679.

The wafer has steps, such as bumps, formed on a circuit surface thereof. The double-faced adhesive tape with adhesion layers on both surfaces of the base material has a thickness larger than an adhesive tape with an adhesion layer on one side of the base material. Accordingly, higher pressure is applied to the double-faced adhesive tape rather than the adhesive tape with an adhesive layer only on one side such that an adhesive of the double-faced adhesive tape enters to adhere gaps formed due to steps on the wafer surface. As a result, bumps may be deformed or damaged in the conventional method.

Moreover, the double-faced adhesive tape has a unique property, and thus inconvenience such as high-cost has also arises.

### SUMMARY OF THE INVENTION

This invention has been made regarding the state as noted above, and its primary object is to provide a mounted wafer manufacturing method that allows accurate manufacture of a mounted wafer with a low-cost configuration.

This invention discloses a method of manufacturing a mounted wafer that supports a semiconductor wafer on a ring frame via a support adhesive tape. The method includes the steps of applying a liquid adhesive to a circuit surface of the semiconductor wafer; joining to a surface of the semiconductor wafer coated with the adhesive a carrier having a shape similar to the semiconductor wafer and a size not less than the semiconductor wafer; grinding a rear face of the semiconductor wafer while holding the carrier; supporting the semiconductor wafer on the ring frame via the support adhesive tape; removing the carrier from the semiconductor wafer; and separating the adhesive tape integrally with the film-like adhesive from the semiconductor wafer through joining a separation tape having a width larger than a diameter of the semiconductor wafer to the adhesive on the semiconductor wafer and then separating the separation tape.

According to this method, the liquid adhesive coated on the circuit surface rapidly immerses into gaps formed due to steps on the wafer surface, and a surface of the adhesive becomes flat. That is, the wafer may entirely be covered with a little amount of adhesive closely with no pressure applied to the wafer surface. Moreover, the carrier may be joined to the surface of the adhesive with no application of excessive pressure. Consequently, there may be avoided deformation or damage of the bumps on the wafer surface due to pressure.

Moreover, the adhesive remaining on the surface of the wafer from which the carrier is removed is cured into a film shape thinner than the adhesive tape. The separation tape having a larger width than the diameter of the wafer is joined to the adhesive, which leads to entire covering of the adhesive with the separation tape. Accordingly, appropriately uniform tension is applied to a separation portion of the adhesive during the separating step, and thus the adhesive may be prevented from partially fracturing and remaining on the wafer surface.

Moreover, in the foregoing separating step, the semiconductor wafer and the ring frame are individually suction-held on each suction table. The separation tape is then joined to the adhesive on the semiconductor wafer while the surface of the semiconductor wafer is higher in level than a surface of the ring frame. Such configuration is preferable.

According to this method, the film-like adhesive is extremely thinner than the adhesive tape. Consequently, a gap (level) between an adhesive surface of the support adhesive tape and the surface of the adhesive is also extremely small, the adhesive surface being exposed between an outer periphery of the semiconductor wafer and the ring frame. Accordingly, the semiconductor wafer has a surface level higher than the ring frame, which results in a larger gap. As a result, upon joining of the separation tape to the surface of the adhesive, joining of the separation tape to the adhesive tape may be avoided even when the separation tape is bent and beyond the outer periphery of the semiconductor wafer. In other words, a separation error may be avoided that occurs due to adhesion of the tapes to each other.

Moreover, in the foregoing separating step, the separation tape is joined to the adhesive on the semiconductor wafer while a plate subjected to a releasing treatment is arranged adjacent to the outer periphery of the semiconductor wafer.

According to this method, the plate receives the separation tape that is bent and beyond the outer periphery of the semiconductor wafer. Consequently, joining of the tapes may accurately be avoided.

Moreover, in the foregoing method, the adhesive is an ultraviolet curable type. In the separating step, ultraviolet rays are applied from a glass carrier side to cure the adhesive, and then the carrier is removed from the adhesive. Such configuration is preferable.

According to this method, irradiation with ultraviolet rays may accelerate a polymerization reaction of the adhesive between the semiconductor wafer and the carrier, and may completely cure the adhesive. Since the adhesive tape thus loses its adhesion, unnecessary tension is not applied to the semiconductor wafer upon removal of the carrier.

This invention also discloses a method of manufacturing a mounted wafer that supports a semiconductor wafer on a ring frame via a support adhesive tape. The method includes the steps of applying a liquid adhesive to a circuit surface of the semiconductor wafer; joining to a surface of the semiconductor wafer coated with the adhesive a carrier having a shape similar to the semiconductor wafer and a size not less than the semiconductor wafer; grinding a rear face of the semiconductor wafer while holding the carrier; supporting the semiconductor wafer on the ring frame via the support adhesive tape; removing the carrier from the semiconductor wafer; joining an adhesive tape to the film-like adhesive on the semiconductor wafer, the adhesive tape being pre-cut in a shape similar to the semiconductor wafer and a size not less than the semiconductor wafer; and separating the adhesive tape integrally with the adhesive from the semiconductor wafer through joining a separation tape to the adhesive tape and then separating the separation tape.

According to this method, the adhesive tape having a shape similar to the semiconductor wafer and a size not less than the semiconductor wafer is joined to the adhesive on the semiconductor wafer. That is, a gap (height) becomes large between an adhesive surface of the support adhesive tape and a face to which the separation tape is joined. Accordingly, upon joining of the separation tape to the adhesive tape, the tapes are hardly joined to each other even when the separation tape is bent and beyond the outer periphery semiconductor wafer. In other words, a separation error may be avoided that occurs due to adhesion of the tapes to each other.

Moreover, in the separating step in the foregoing method, the separation tape narrower than a diameter of the semiconductor wafer may be joined to the adhesive.

That is, the adhesive tape in a wafer shape is joined to the film-like adhesive, which results in reinforcement of the adhesive. Accordingly, when the separation tape is joined that is narrower than the diameter of the semiconductor wafer, tension is partially absorbed in the base material forming the adhesive tape. Consequently, the film-like adhesive may be prevented from partially fracturing and remaining on the semiconductor wafer.

Moreover, in the foregoing method, the adhesive is an ultraviolet curable type. In the separating step, ultraviolet rays are applied from a glass carrier side to cure the adhesive, and then the carrier is removed from the adhesive. Such configuration is preferable.

According to this method, irradiation with ultraviolet rays may accelerate a polymerization reaction of the adhesive between the semiconductor wafer and the carrier, and may completely cure the adhesive. Since the adhesive tape thus loses its adhesion, unnecessary tension is not applied to the semiconductor wafer upon removal of the carrier.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flow chart of manufacturing a mounted wafer according to Embodiment 1.

FIG. 2 is a front view showing operations in an adhesive application step.

FIGS. 3 and 4 are front views each showing operations in a carrier joining step.

FIGS. 5 and 6 are front views each showing operations in a back grinding step.

FIG. 7 is a front view showing operations in a supporting step.

FIG. 8 is a front view schematically showing a configuration of the supporting step.

FIG. 9 is a front view showing operations in the supporting step.

FIG. 10 is a plan view of a tape cutting mechanism.

FIGS. 11 and 12 are front views each showing operations in the supporting step.

FIGS. 13 and 14 are front views each showing operations in a removal step.

FIG. 15 is a front view schematically showing a configuration of a separating step.

FIGS. 16 to 18 are front views each showing operations in the separating step.

FIG. 19 is a perspective view showing separation.

FIG. 20 is a front views showing operations in the separating step.

FIG. 21 is a perspective view of a mounted wafer.

FIG. 22 is a flow chart of manufacturing a mounted wafer according to Embodiment 2.

FIG. 23 is a front view schematically showing a configuration of a joining step.

FIG. 24 is a perspective view showing operations in the joining step.

FIG. 25 is a front view showing operations in the joining step.

FIG. 26 is a front view schematically showing a configuration of a separating step.

FIG. 27 is a perspective view showing operations in the separating step.

FIG. 28 is a front view showing operations of joining a separation tape in a separating step according to one modification.

### DESCRIPTION OF THE PREFERRED EMBODIMENTS

One embodiment of this invention is now to be described below with reference to the drawings.

### Embodiment 1

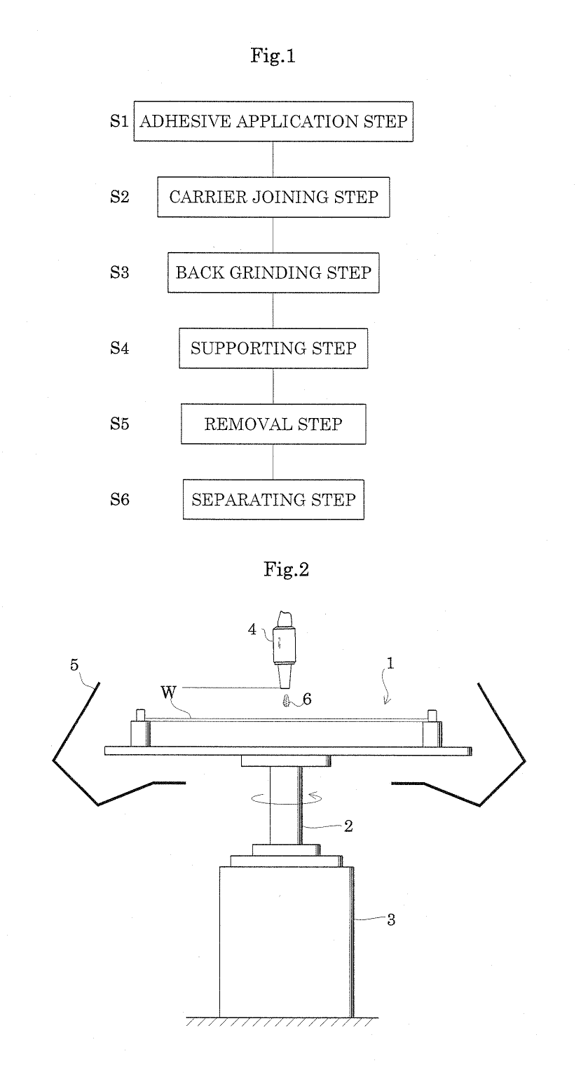

As shown in FIG. 1, this embodiment includes an adhesive application step S1, a carrier joining step S2, a back grinding step S3, a supporting step S4, a removal step S5, and a separating step S6.

In the adhesive application step S1, an adhesive is applied to a semiconductor wafer W (hereinafter, simply referred to as a “wafer W”) having a circuit formed on a surface thereof. For instance, as shown in FIG. 2, a spin chuck 1, a rotation shaft 2, an electric motor 3, a nozzle 4, and a scattering prevention cup 5 are arranged in the adhesive application process S1.

Specifically, a liquid adhesive 6 is applied from the nozzle 4 towards a center of the wafer W while the spin chuck 1 having the circuit surface directed upward rotates through rotation of the electric motor 3. The applied adhesive 6 spreads radially due to centrifugal force towards an outer periphery of the wafer W. The spin chuck 1 spins off an unnecessary adhesive, and the scattering prevention cup 5 provided around the outer periphery of the wafer W collects the unnecessary adhesive. At this time, the adhesive 6 immersing into a gap formed by a step such as a circuit or a bump on the surface of the wafer W.

When the spin chuck 1 stops rotation, the wafer W is entirely covered with the adhesive in a uniform thickness such that no adhesive drops down. Here, the adhesive 6 has a thickness of around several micrometers that covers the wafer W. The thickness is variable in accordance with a property of the adhesive 6. That is, an amount of the adhesive 6 to be applied is determined in advance through repeated experiments or simulations depending on types of wafers W and adhesives to be used.

The adhesive 6 used herein is an ultraviolet curable type adhesive with acid resistance, alkali resistance, and chemical resistance.

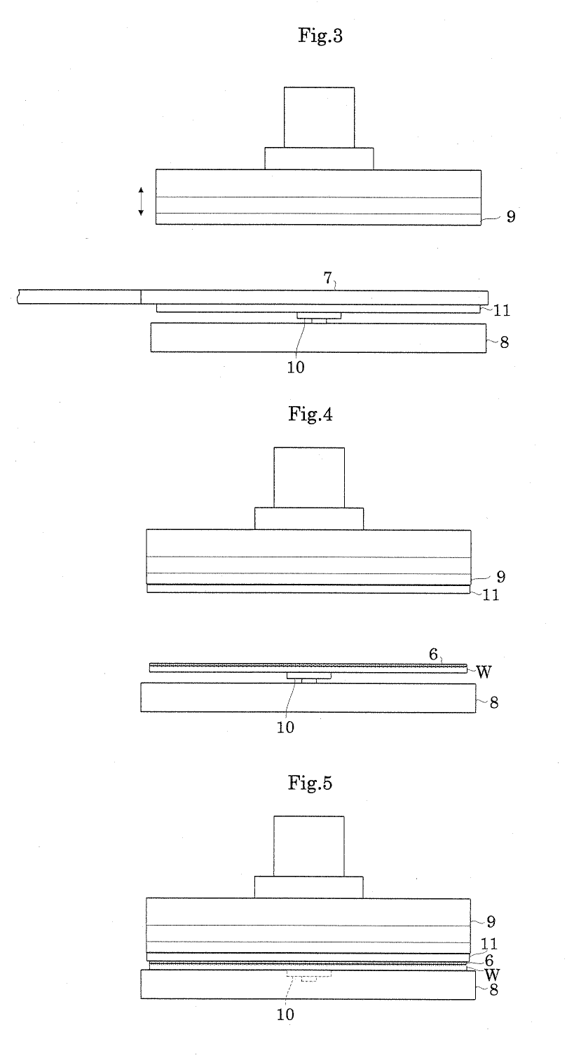

As shown in FIG. 3, the wafer W having the adhesive 6 applied thereto is transported to the carrier joining step S2 while a rear face thereof is suction-held with a transportation robot 7 having a U-shaped arm on its tip end.

In the carrier joining step S2, the carrier joining mechanism is provided including lower and upper suction tables 8 and 9 with an alignment function.

A suction pad 10 is arranged at a center of the lower suction table 8 that allows upward/downward movement and rotation. Firstly, the transportation robot 7 transports a glass carrier 11 having a similar shape and a size not less than the wafer W onto the lower suction table 8, and is delivered on the suction pad 10 in an upward state. The suction pad 10 suction-holding the carrier 11 rotates to detect an outer peripheral position of the carrier 11 (coordinate) during rotation, thereby determining a center position of the carrier 11 based on the detection results.

When the center position is determined, the suction pad 10 moves downward. The upper suction table 9 moves downward to suction-hold the carrier 11, and retracts upward, as shown in FIG. 4.

Next, the transportation robot 7 transports the wafer W onto the lower suction table 8, and delivers the wafer W on the suction pad 10 in an upward state. The suction pad 10 suction-holding the wafer W rotates to detect an orientation mark or notch formed at an outer periphery of the wafer W during rotation, thereby determining a center position of the wafer W. The wafer W is aligned based on information obtained as above, and thereafter the suction pad 10 moves downward.

When alignment of the wafer W is completed, the upper suction table 9 moves downward to contact or slightly press the rear face of the carrier 11 to the adhesive 6, thereby joining the carrier 11 to the adhesive 6, as shown in FIG. 5. After the carrier 11 is aligned with and joined to the wafer W, the transportation robot suction-holds the surface of the carrier 11 and transports it to the back grinding step S3.

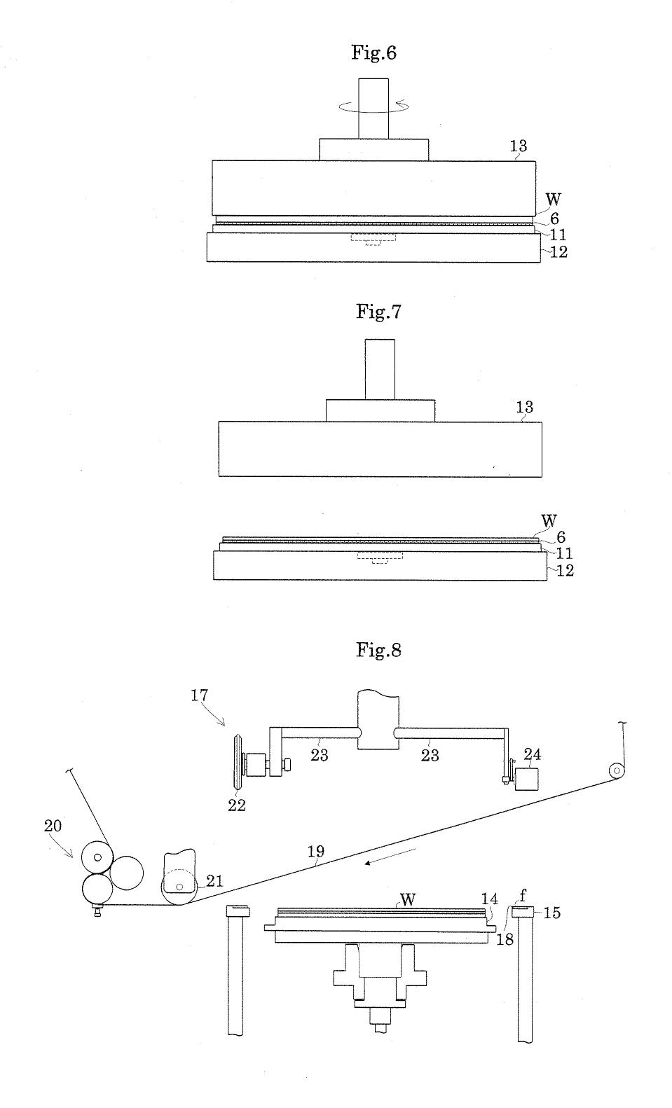

In the back grinding step S 3 as shown in FIGS. 6 and 7, a chuck table 12 and a grinder 13 are provided.

The grinder 13 grinds the rear face of the wafer W to a given thickness while the chuck table 12 suction-holds the surface of the carrier 11. Such as dust on the wafer W having a given thickness is then removed. Subsequently, the transportation robot transports the wafer W into the supporting step S4.

In the supporting step S4 as shown in FIG. 8, a tape supply section, a chuck table 14, a frame holder 15, a tape joining mechanism, a tape cutting mechanism 17, and a tape collecting section are provided.

Firstly, the chuck table 14 that allows upward/downward movement receives the wafer W from the transportation robot in an upward state slightly higher than the frame holder 15. Herein, the rear face of the wafer W is directed upward. The chuck table 14 suction-holding the wafer W moves downward such that the surface of a ring frame f is flush with the rear face of the wafer W when the ring frame f is placed on a step 18 of the frame holder 15.

Subsequently, the transportation robot places the ring frame f on the frame holder 15.

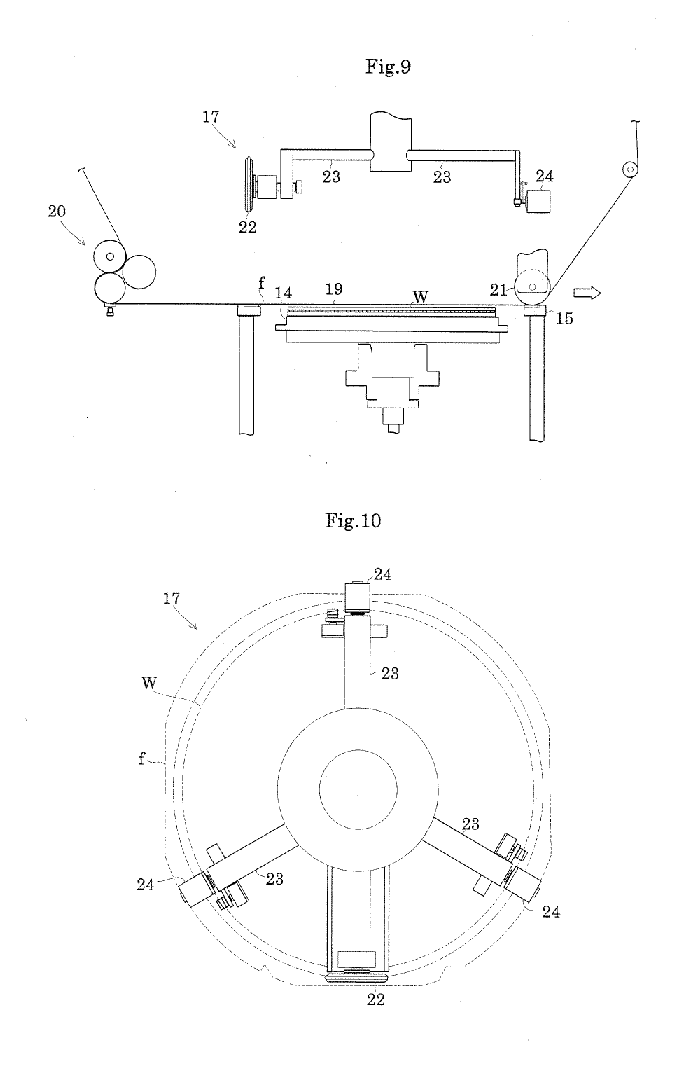

Upon completion of setting the wafer W and the ring frame f, a support adhesive tape 19 is joined to the ring frame f, the support adhesive tape 19 passing from the tape supply section above the wafer W and the ring frame f to be wounded in the tape collecting section. That is, as shown in FIG. 9, a nip roller 20 on a downstream side nips the adhesive tape 19 while applying a given tension. A joining roller 21 rolls on the adhesive tape 19 from the downstream side toward an upper stream side in a tape supply direction, thereby joining the adhesive tape 19 to the ring frame f. Here, the tape supply section feeds out a given amount of the adhesive tape 19 while being synchronized to rolling of the joining roller 21 such that a given tension is applied to the adhesive tape 19.

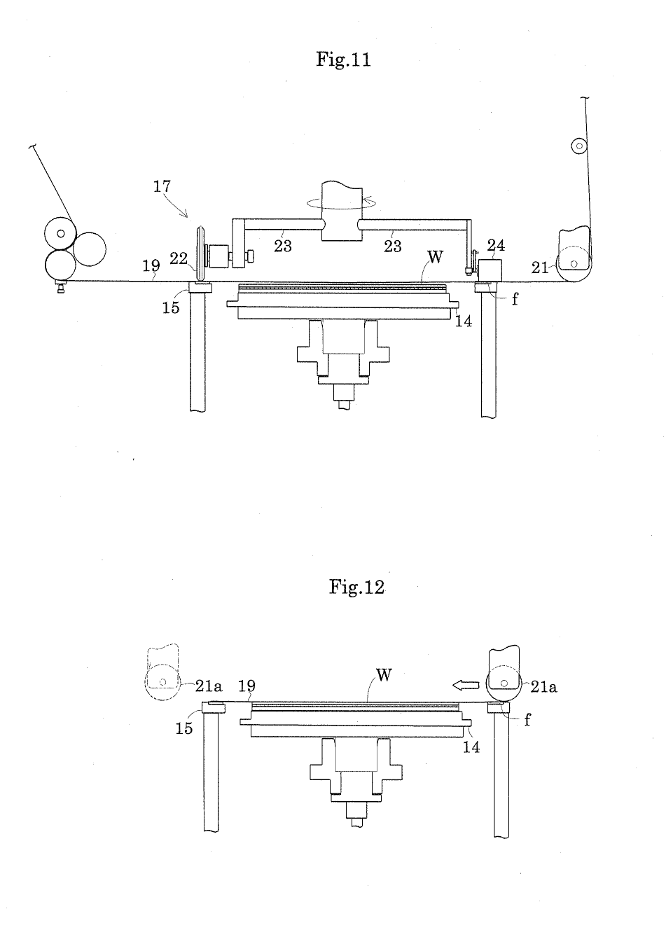

When the joining roller 21 passes over the ring frame f to reach a termination position, the tape cutting mechanism 17 moves downward to cut the adhesive tape 19 in a shape of the ring frame f while pivoting about a center of the ring frame f, as shown in FIG. 11. Herein, as shown in FIG. 10, each roller 24 of three arms 23 arranged coaxially with a cutter blade 22 presses a floating portion of the adhesive tape 19 cut with the cutter blade 22 to join it to the ring frame f.

Upon completion of cutting the adhesive tape 19, the tape cutting mechanism 17 returns to its standby position on an upper side, and the nip roller 20 releases its nipping such that the adhesive tape 19 cut out is wounded and collected.

Subsequently, the chuck table 14 moves upward to a given level. Specifically, the adhesive tape 19 faces close to the rear face of the wafer W. Under this state as shown in FIG. 12, another joining roller 21a rolls from the upstream side toward the downstream side in the tape supply direction, thereby joining while pressing the adhesive tape 19 to the rear face of the wafer W. The wafer W supported on the ring frame f having the joining tape 19 joined thereto is transported to the separating step S5 with the transportation robot.

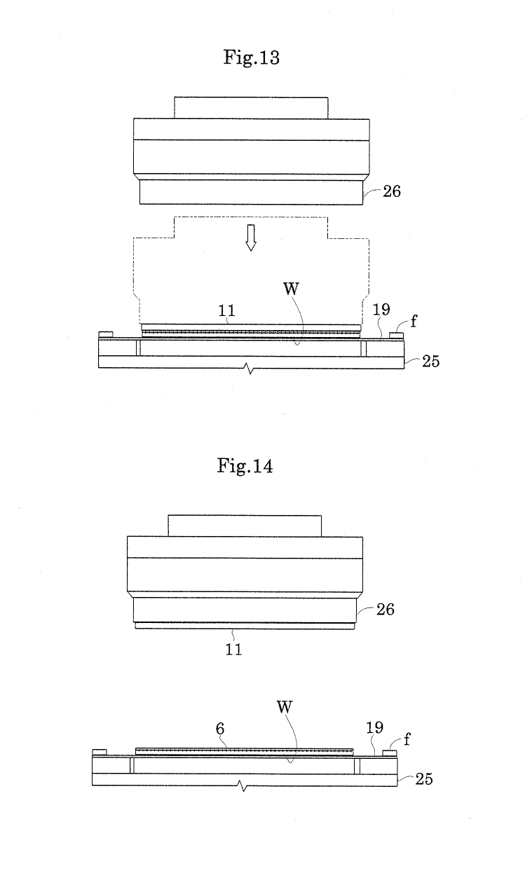

In the separating step S5 as shown in FIG. 13, provided are a lower suction table 25, an ultraviolet irradiation unit, and an upper suction table 26.

The lower suction table 25 suction-holds the rear faces of the wafer W and the ring frame f. The retractable ultraviolet irradiation unit provided above the carrier irradiates the carrier 11 with ultraviolet-rays. Irradiation time with ultraviolet-rays is set in advance such that irradiation with ultraviolet-rays transmitting the carrier 11 may accelerate a polymerization reaction of the adhesive 6 and lose adhesion thereof. Herein, the ultraviolet irradiation unit may be an ultraviolet lamp, an ultraviolet LED, or an ultraviolet laser. When an ultraviolet layer is adopted, a focus thereof is on an interface between the support plate 11 and the adhesive 6.

Upon completion of an ultraviolet treatment, the ultraviolet irradiation unit returns to its standby position, and the upper suction table 26 moves downward to suction-hold the carrier 11. When it is confirmed that the carrier 11 is suction-held, the upper suction table 26 moves upward to remove the cattier 11 from the adhesive 6, as shown in FIG. 14. The wafer W from which the carrier 11 is removed is transported to the separating step S6.

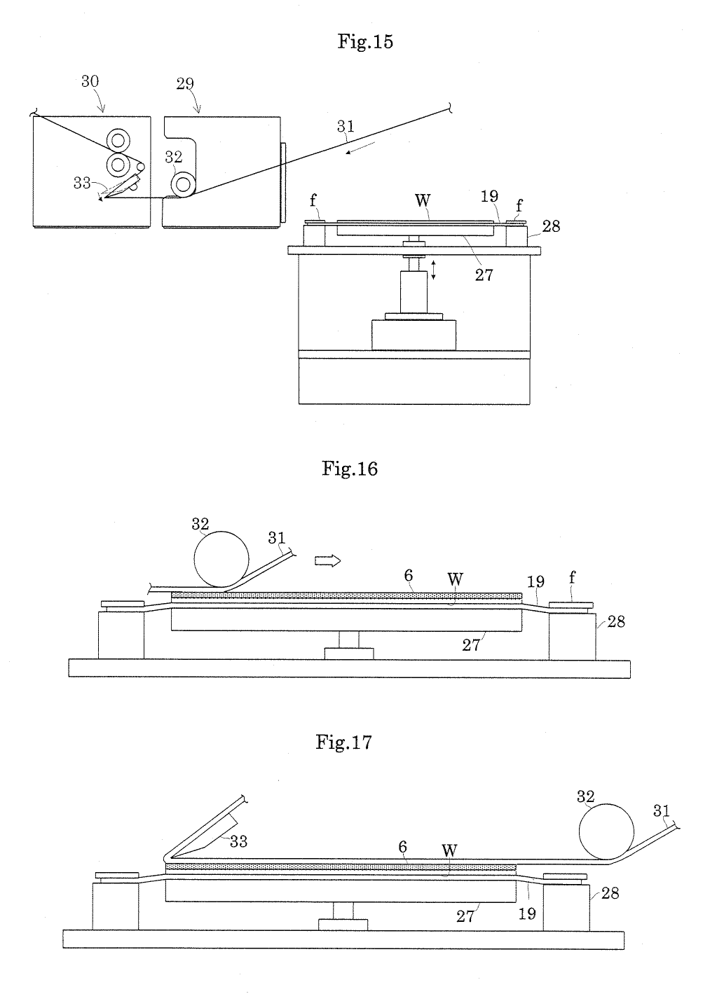

In the separating step S6 as shown in FIG. 15, provided are a separation tape supply section, a chuck table 27, a frame holder 28, a joining unit 29, a separation unit 30, and a tape collecting section.

The frame holder 28 and the chuck table 27 suction-hold the ring frame f and the wafer W. Herein, the ring frame f is flush with the wafer W. Subsequently, the chuck table 27 moves upward, as shown in FIG. 16. Accordingly, a gap between the surface of the film-like adhesive 6 and the adhesive surface of the adhesive tape 19 increases, compared to that where the chuck table 27 is in a steady state.

Upon completion of setting the wafer W and the ring frame f, the separation tape 31 having a larger width than the diameter of the wafer W is joined to the adhesive 6. Here, the separation tape 31 in the tape supply section passes over the wafer W and the ring frame f to be wounded on the tape collecting section. That is, a joining roller 32 in the joining unit 29 rolls on the separation tape 31 from downstream toward upstream in the tape supply direction that is nipped with a nip roller in the separation unit on the downstream side to apply a given tension. At this time, the tape supply section feeds out a given amount of the separation tape 31 while being synchronized to rolling of the joining roller 32 such that a given tension is applied to the separation tape 31.

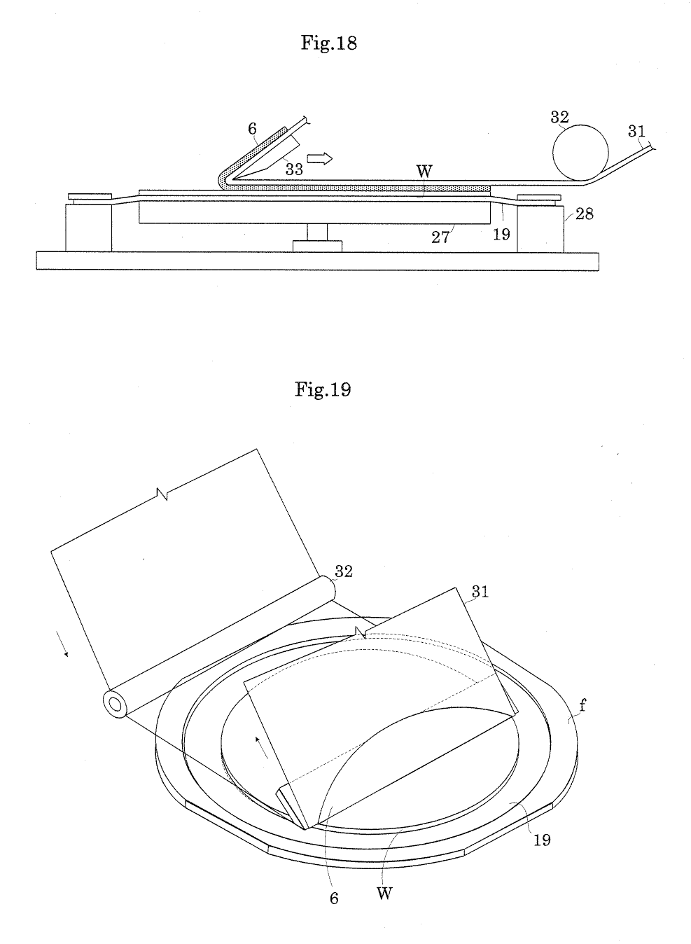

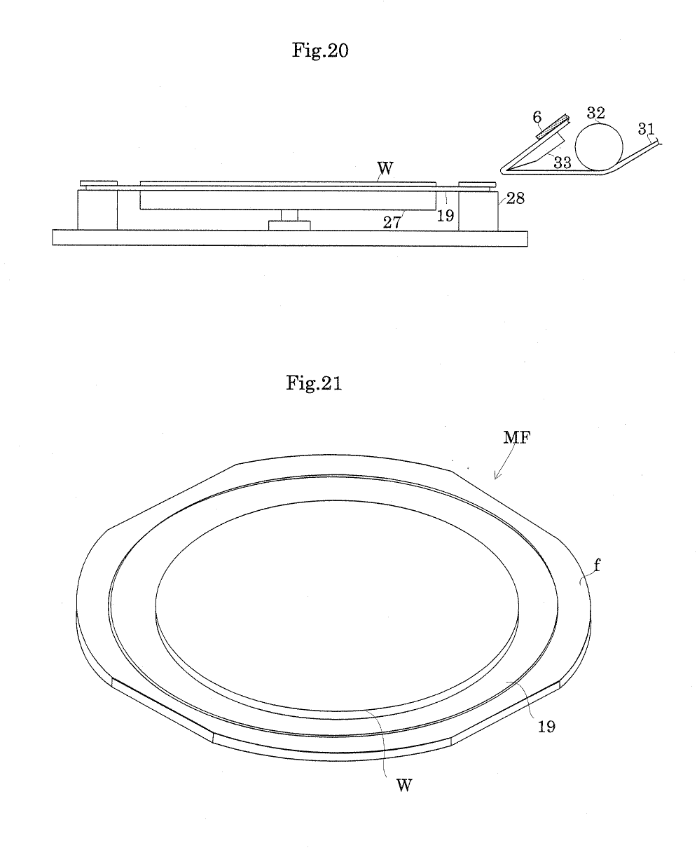

When the joining roller 32 rolls over the ring frame f to reach a termination position, nipping of the separation tape 31 with the nipping roller is released to move the separation unit 30 upstream, as shown in FIGS. 17 to 19. Here, as shown in FIG. 20, a tip end of an edge member 33 provided in the separation unit 30 folds back the separation tape 31 for separation. Moreover, the tape collection section winds and collects the separation tape 31 integrally with the adhesive 6 while synchronizing the separation.

When the separation unit 30 reaches the termination position, the chuck table 27 moves downward, and then the separation unit 30 and the joining unit 29 each return to its initial position. A series of manufacturing a mounted wafer is to be completed as above, and a mounted wafer MF is to be manufactured as in FIG. 21.

According to the foregoing mounted wafer manufacturing method, a given amount of the liquid adhesive 6 is applied on the circuit surface of the wafer W turned and held by the spin chuck 1, whereby the adhesive 6 enters to adhere gaps formed on the circuit surface. That is, the surface of the adhesive 6 may be flat. In other words, both when the circuit surface of the wafer W is coated with the adhesive 6 and when the carrier 11 is joined to the adhesive 6, no stress is applied to the wafer W due to excessive pressure. Accordingly, damage of the circuit or bumps on the wafer W may be avoided.

In addition, the foregoing embodiment may solve the following problem. Specifically, it is general in the conventional method that the separation tape narrower than the diameter of the wafer W is joined to the double-faced adhesive tape remaining on the wafer W, and thereafter is separated. Where the separation tape is adopted, however, a local tension is applied to the film-like adhesive 6 having reduced adhesion. Consequently, there may arise a problem that the adhesive 6 is torn along a side edge from a separated portion of the separation tape, which leads to remaining of a torn adhesive 6.

According to this embodiment, the separation tape 31 is joined to and separated from the film-like adhesive 6, that is thinner than an adhesive tape with an adhesive layer on one side and an double-the faced adhesive tape, as to cover the entire surface of the adhesive 6. Consequently, there may be suppressed remaining of the adhesive 6 on the circuit surface of the wafer W.

Moreover, when the separation tape 31 is joined to the adhesive 6, the chuck table 27 moves upward. Consequently, a larger gap may be generated between the adhesive surface of the adhesive tape 19 and the surface of the adhesive 6, compared to the case where the ring frame f and the wafer W are held as to be flush with each other. That is, the tapes may be prevented from being joined together even when the separation tape 31 is bent and beyond the outer periphery of the wafer W. Consequently, it is not necessary to apply a high tension for releasing joining of the tapes. In other words, there may be avoided damages in the wafer W due to excessive tension as well as separation errors.

### Embodiment 2

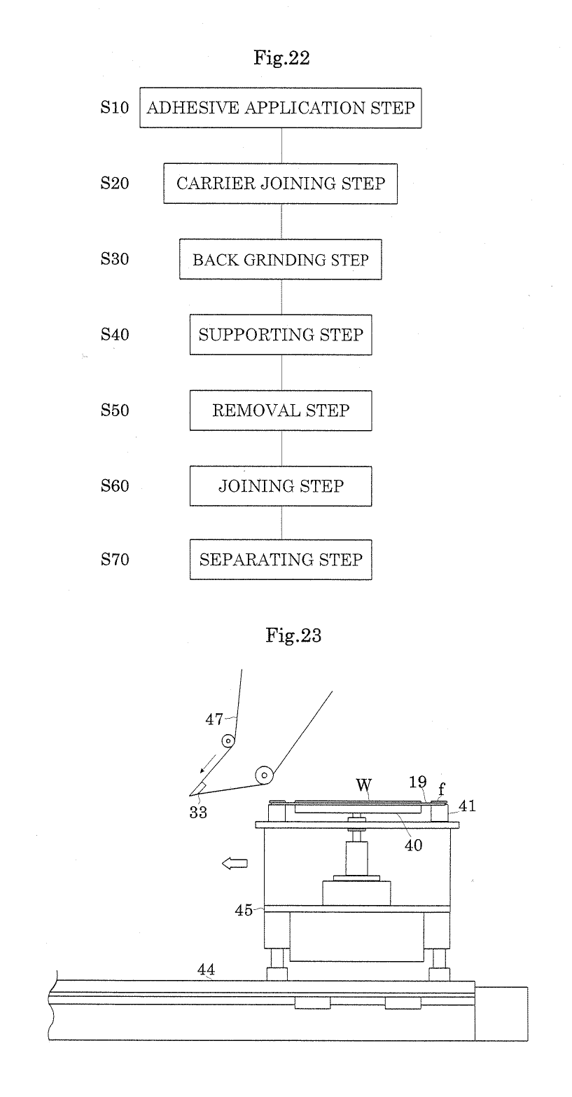

As shown in FIG. 22, this embodiment includes an adhesive application step S10, a carrier joining step S20, a back grinding step S30, a supporting step S40, a removal step S50, a joining step S60, and a separating step S70. Herein, same processes as in Embodiment 1 are to be performed from the adhesive application step S10 to the removal step S50. Thus, description will be given of steps subsequent to the joining step S60 with different processes.

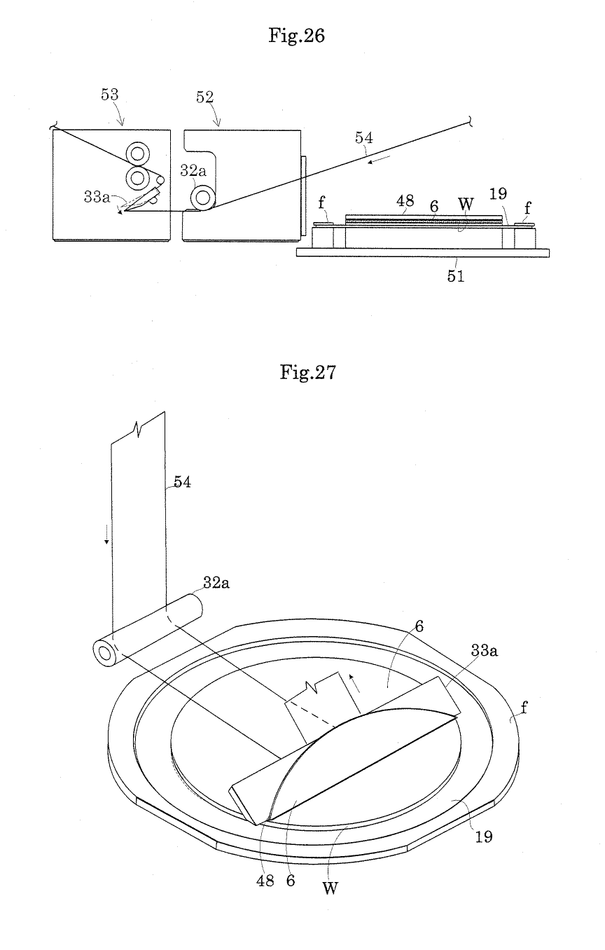

The carrier 11 is removed from the wafer W. The wafer W is transported to the joining step S60. In the joining step S60 as shown in FIGS. 23 and 26, provided are a separation tape supply section, a chuck table 40, a frame holder 41, a joining unit, a separation unit, and a tape collecting section.

The frame holder 41 and the chuck table 40 suction-hold the ring frame f and the wafer W, the frame holder 41 and the chuck table 40 being provided on a movable table 45 that allows movement along a guide rail 44. Herein, the ring frame f is flush with the wafer W.

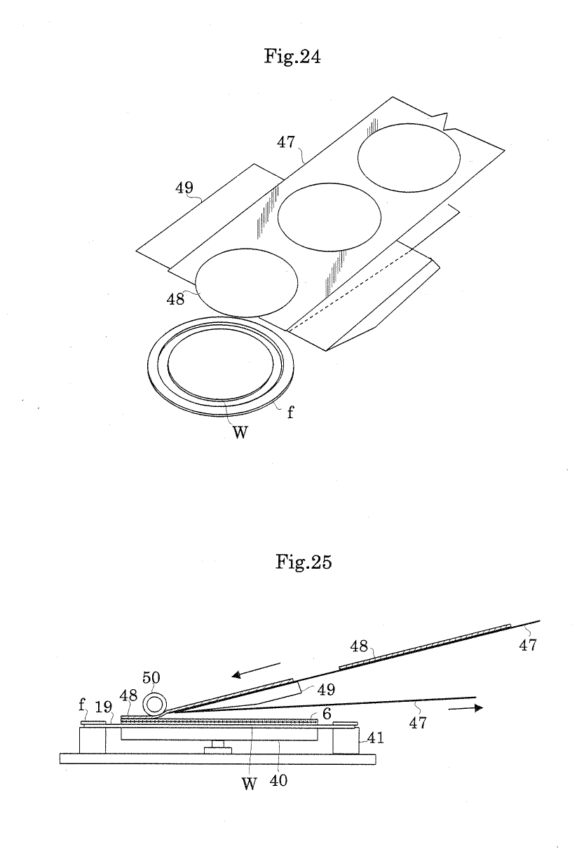

Upon completion of setting the wafer W and the ring frame f, a pre-cut adhesive tape 48 (pre-cut tape) is supplied toward the wafer W. Here, as shown in FIG. 24, the adhesive tapes 48 are provided on a strip carrier tape 47 at given pitches, and each have a shape similar to the wafer W and a size not less than the wafer W.

The carrier tape 47 is folded back with an edge member 49 provided in a joining position that separates the adhesive tape 48 from the carrier tape 47. A joining roller 50 in the joining unit 42 in a standby state above the joining position moves downward, thereby joining while pressing the adhesive tape 48 adjacent to an end of the adhesive 6 on the wafer W. Next, the movable table 45 moves at a speed synchronized to that of feeding the carrier tape 47, whereby the joining roller 50 rolls. Herein, the adhesive tape 48 is joined to the adhesive 6. Upon completion of joining the adhesive tape 48, the wafer W is transported to the separating step 70.

In the separating step S70 as shown in FIG. 26, provided are a separation tape supply section, a chuck table 51, a joining unit 52, a separation unit 53, and a tape collecting section.

The chuck table 51 suction-holds the ring frame f and the wafer W. Herein, the ring frame f is flush with the wafer W.

Upon completion of setting the wafer W and the ring frame f, a separation tape 54 narrower than the diameter of the wafer W is joined to the adhesive tape 48 on the wafer W, as shown in FIG. 27. Here, the separation tape 54 in the tape supply section passes over the wafer W and the ring frame f to be wounded on the tape collecting section. Specifically, a joining roller 32a provided in the joining unit 52 rolls on the separation tape 54 from a downstream side toward an upstream side in the tape supply direction that is nipped with the nip roller in the separation unit 53 on the downstream side to apply a given tension.

At this time, the tape supply section feeds out a given amount of the separation tape 54 while being synchronized to rolling of the joining roller 32a such that a given tension is applied to the separation tape 54.

When the joining roller 32a rolls over the ring frame f to reach a termination position, nipping of the separation tape 31 with the nipping roller is released to move the separation unit 53 upstream. Here, a tip end of an edge member 33a provided in the separation unit 53 folds back the separation tape 54 for separation. Moreover, the tape collection section winds and collects the separation tape 54 integrally with the adhesive 6 and the adhesive tape 48 while synchronizing the separation.

When the separation unit 53 reaches the termination position, the separation unit 53 and the joining unit 52 each return to its initial position. A series of manufacturing a mounted wafer is to be completed as above, and a mounted wafer MF is to be manufactured as in FIG. 21.

According to the foregoing mounted wafer manufacturing method, a given amount of the adhesive 6 is applied on the adhesive tape 48 having a similar shape to the wafer W and a size not less than the wafer W. Consequently, a larger gap may be generated between the adhesive surface of the adhesive tape 48 and the surface of the adhesive 6, compared to the case where the ring frame f and the wafer W are held as to be flush with each other. That is, the tapes may be prevented from being joined together even when the separation tape 54 is bent and beyond the outer periphery of the wafer W. Consequently, it is not necessary to apply a high tension for releasing joining of the tapes. In other words, there may be avoided damages in the wafer W due to excessive tension as well as separation errors.

This invention may be embodied as the following aspects.

(1) In the separating step S70 in Embodiment 2, the chuck table that allows upward/downward movement suction-holds the wafer W. The frame holder suction-holds the ring frame f. The chuck table moves upward to join the separation tape 54 to the adhesive tape 48. Such configuration similar to that in Embodiment 1 may be adopted.

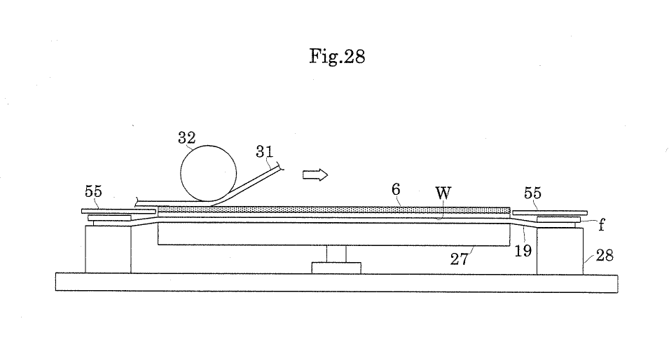

(2) In both foregoing embodiments and the modification, a plate 55 subject to a releasing treatment is provided around the outer periphery of the wafer W on sides where a tape joining starts and ends, as shown in FIG. 28. Such configuration may be adopted. This configuration may realize reception of a portion of the separation tape that is bend and beyond the outer periphery of the wafer W. Consequently, there may be certainly suppressed adhesion of the adhesive tape 19 and the separation tape 31, 54.

(3) In the joining step in the foregoing Embodiment 2, two or more adhesive tapes 48 may be joined in a stack manner.

(4) In each carrier joining step in the foregoing embodiments, a heater is embedded within at least any of the upper suction table 26 and the lower suction table 25, and the carrier 11 is joined while the heater heats the adhesive 6. Such configuration may be adopted.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of manufacturing a mounted wafer that supports a semiconductor wafer on a ring frame via a support adhesive tape, comprising the steps of:
applying a liquid adhesive to a circuit surface of the semiconductor wafer;
joining to a surface of the semiconductor wafer coated with the adhesive a carrier having a shape similar to the semiconductor wafer and a size not less than the semiconductor wafer;
grinding a rear face of the semiconductor wafer while holding the carrier;
supporting the semiconductor wafer on the ring frame via the support adhesive tape;
removing the carrier from the semiconductor wafer; and
separating the adhesive tape integrally with the film-like adhesive from the semiconductor wafer through joining a separation tape having a width larger than a diameter of the semiconductor wafer to the adhesive on the semiconductor wafer and then separating the separation tape.

2. The method of manufacturing the mounted wafer according to claim 1, wherein, in the separating step, the semiconductor wafer and the ring frame are individually suction-held on each suction table, and the separation tape is joined to the adhesive on the semiconductor wafer while the surface of the semiconductor wafer is higher in level than a surface of the ring frame.

3. The method of manufacturing the mounted wafer according to claim 2, wherein, in the separating step, the separation tape is joined to the adhesive on the semiconductor wafer while a plate subjected to a releasing treatment is arranged adjacent to the outer periphery of the semiconductor wafer.

4. The method of manufacturing the mounted wafer according to claim 1, wherein the adhesive is an ultraviolet curable type, and in the separating step, ultraviolet rays are applied from a glass carrier side to cure the adhesive, and then the carrier is removed from the adhesive.

5. A method of manufacturing a mounted wafer that supports a semiconductor wafer on a ring frame via a support adhesive tape, comprising the steps of:
applying a liquid adhesive to a circuit surface of the semiconductor wafer;
joining to a surface of the semiconductor wafer coated with the adhesive a carrier having a shape similar to the semiconductor wafer and a size not less than the semiconductor wafer;
grinding a rear face of the semiconductor wafer while holding the carrier;
supporting the semiconductor wafer on the ring frame via the support adhesive tape;
removing the carrier from the semiconductor wafer;
joining an adhesive tape to the film-like adhesive on the semiconductor wafer, the adhesive tape being pre-cut in a shape similar to the semiconductor wafer and a size not less than the semiconductor wafer; and
separating the adhesive tape integrally with the adhesive from the semiconductor wafer through joining a separation tape to the adhesive tape and then separating the separation tape.

6. The method of manufacturing the mounted wafer according to claim 5, wherein, in the separating step, the separation tape narrower than a diameter of the semiconductor wafer is joined to the adhesive.

7. The method of manufacturing the mounted wafer according to claim 5, wherein the adhesive is an ultraviolet curable type, and in the separating step, ultraviolet rays are applied from a glass carrier side to cure the adhesive, and then the carrier is removed from the adhesive.
